(19) United States
(12) Patent Application Publication
(10) Pub. No.: US 2003/0190826 A1
(43) Pub. Date: Oct. 9, 2003

(54) Test fixture for semiconductor packages and test method of using the same

(75) Inventors: Huan-Ping Su, Hsinchu (TW); Soon-Aik Lu, Hsinchu (TW)

Correspondence Address: EDWARDS & ANGELL, LLP, P.O. BOX 9169, BOSTON, MA, 02209, US

(73) Assignee: UltraTera Corporation, Hsinchu (TW)

(21) Appl. No.: 10/175,731

(22) Filed: Jun. 20, 2002

(30) Foreign Application Priority Data
Apr. 8, 2002 (TW) 91107920

(51) Int. Cl. H01R 12/00

(52) U.S. Cl. 439/71

(57) ABSTRACT

A test fixture for semiconductor packages and a test method of using the test fixture are proposed. The test fixture is composed of a first circuit board, a second circuit board, an interposer and a covering member. The first and second circuit boards are used to accommodate semiconductor packages and electrically connect the semiconductor packages to a test device, in a manner that the second circuit board is interposed between the semiconductor packages and the first circuit board. The interposer is mounted on the second circuit board, and formed with through holes for receiving the semiconductor packages therein. The covering member is attached onto the interposer, and provided with elastic mechanisms for holding the semiconductor packages in position. By using the test fixture, semiconductor packages can be firmly coupled to the test device where functional tests are performed.

### FIELD OF THE INVENTION

The present invention relates to test fixtures for semiconductor packages and test methods of using the test fixtures, and more particularly, to a test fixture for use with BGA (ball grid array) semiconductor packages, and a method for testing the semiconductor packages through the use of the test fixture.

### BACKGROUND OF THE INVENTION

Conventionally, fabricated semiconductor packages are electrically connected by a test fixture to a test device e.g. a test oven for performing various functional tests, such as direct current test, bum-in test, room/cold test, hot sort test, etc; these tests are used to test functionality of the semiconductor packages, for selecting good-quality packages and eliminating inferior products, thereby assuring yield of package fabrication. Since the above functional tests are conventional in the art, they are not to be further described herein.

FIGS. 1A and 1B illustrate BGA (ball grid array) semiconductor packages 10 mounted on a circuit board 11 of a conventional test fixture, for electrically connecting the semiconductor packages 10 through the text fixture to a test device (not shown) where functional tests are performed. As shown in the drawings, the circuit board 11 is formed with a plurality of contact terminals 12 that are adapted to be in contact with solder balls 13 acting as input/output (I/O) connections of the semiconductor packages 10. Each of the contact terminals 12 is provided with three contacts for use to hold a corresponding solder ball 13 in position; since such a three-contact design is conventional in the art, it is not further to be described herein. Therefore, with electrical contact between solder balls 13 of the semiconductor packages 10 and contact terminals 12 formed on the circuit board 11, by electrically connecting I/O ports 14 of the circuit board 11 to the test device, the semiconductor packages 10 can be electrically coupled to the test device where desirable functional tests are performed.

However, the above conventional test fixture has significant drawbacks. First, when semiconductor packages are mounted on a circuit board of the test fixture, solder balls of the semiconductor packages may not be precisely positioned on contact terminals of the circuit board, which deteriorates electrical contact or connection quality between the semiconductor packages and the circuit board/test fixture, thereby adversely affecting test performance for the semiconductor packages. Moreover, it usually employs a pressing mechanism or external force to press the semiconductor packages toward the circuit board, for the purpose of assuring electrical contact between the semiconductor packages and the circuit board; however, due to considerably strong rigidity of the multi-layered circuit board (e.g. more than ten layers, or even several decades of layers), pressing on the semiconductor packages would possibly damage solder balls, making yield of fabricated products undesirably degraded. In addition, the circuit board is formed with fixed-density arrangement of contact mechanisms, and thus, only certain types of semiconductor packages with corresponding density of solder balls can be accommodated on the circuit board. Therefore, in response to semiconductor packages with various densities of solder balls, a multiplicity of circuit boards with different arrangement of contact mechanisms are necessarily prepared; however, such a multi-layered circuit board is expensively fabricated, thereby making overall production costs of the test fixture significantly increased.

Therefore, how to develop a test fixture for assuring electrical connection between semiconductor packages and the test fixture, as well as to maintain yield of fabricated products and to reduce fabrication costs, is a critical problem to solve.

### SUMMARY OF THE INVENTION

An objective of the present invention is to provide a test fixture for semiconductor packages and a test method of using the test fixture, whereby semiconductor packages can be well in electrical contact with the test fixture and electrically connected to a test device where tests are performed for the semiconductor packages.

Another objective of the invention is to provide a test fixture for semiconductor packages and a test method of using the test fixture, wherein the test fixture can be applied to semiconductor packages of different sizes and with various densities in arrangement of input/output (I/O) connections.

A further objective of the invention is to provide a test fixture for semiconductor packages and a test method of using the test fixture, wherein the test fixture can be cost-effectively fabricated by simplified processes, and adapted to assure quality and yield of semiconductor packages without damaging the semiconductor packages during test performance.

In accordance with the above and other objectives, the present invention proposes a test fixture for semiconductor packages and a test method of using the test fixture. The test fixture is used to electrically connect a plurality of BGA (ball grid array) semiconductor packages to a test device where tests are performed for the semiconductor packages.

The test fixture comprises: a first circuit board formed on a surface thereof with a plurality of contact mechanisms, and adapted to be electrically connected to the test device; a second circuit board having an upper surface and a lower surface opposed to the upper surface, wherein the upper surface is adapted for accommodating a plurality of semiconductor packages thereon, and the lower surface is mounted on the contact mechanisms of the first circuit board in a manner that, the second circuit board is interposed between the semiconductor packages and the first circuit board, allowing the semiconductor packages to be electrically connected to the first circuit board and the test device by the second circuit board; an interposer mounted on the upper surface of the second circuit board, and formed with a plurality of through holes that penetrate through the interposer, so as to allow the semiconductor packages accommodated on the second circuit board to be received in the through holes respectively; and a covering member mounted on the interposer, for covering the semiconductor packages received in the through holes.

The test method of using the above test fixture comprises the steps of: preparing a first circuit board, the first circuit board being formed on a surface thereof with a plurality of contact mechanisms; preparing a second circuit board, the second circuit board having an upper surface and a lower surface opposed to the upper surface, and mounting the lower surface of the second circuit board on the contact mechanisms of the first circuit board; mounting an interposer on the upper surface of the second circuit board, the interposer being formed with a plurality of through holes that penetrate through the interposer; disposing a plurality of semiconductor packages respectively in the through holes of the interposer in a manner as to accommodate the semiconductor packages on the upper surface of the second circuit board, allowing the semiconductor packages to be electrically connected to the first circuit board by the second circuit board; attaching a covering member to the interposer, for covering the semiconductor packages received in the through holes; and electrically connecting the first circuit board to the test device, so as to allow the semiconductor packages to be electrically connected to the test device where tests are performed.

The test fixture of the invention provides significant benefits. First, the test fixture is additionally provided with a second circuit board for mediating electrical connection between semiconductor packages and a first circuit board in a manner that, I/O connections (such as solder balls) of the semiconductor packages are in contact with an upper surface of the second circuit board (i.e. point-to-surface contact), and a lower surface of the second circuit board is in contact with contact mechanisms of the first circuit board (i.e. surface-to-point contact). Compared to the prior art of disposing I/O connections of semiconductor packages directly on contact mechanisms of a circuit board (i.e. point-to-point contact), which may easily lead to problems of incomplete electrical connection, the point-to-surface or surface-to-point contact of the invention can more firmly assure electrical connection between the semiconductor packages and second circuit board and between the second circuit board and first circuit board, such that the semiconductor packages would be completely electrically coupled through the first and second circuit boards to a test device where functional tests are performed.

Moreover, the test fixture of the invention can be applied to semiconductor packages of different sizes and with various densities in arrangement of I/O connections. With provision of the second circuit board being interposed between the semiconductor packages and the first circuit board, for accommodating semiconductor packages with various densities of I/O connections, the test fixture can be simply replaced with a second circuit board having bond pads arranged corresponding in density or position to I/O connections of the semiconductor packages. For accommodating semiconductor packages of different sizes, the test fixture can use an interposer formed with through holes corresponding in dimension to the semiconductor packages, whereby the semiconductor packages can be properly received in the through holes and firmly held in position on the second circuit board. In the invention, a single first circuit board is universally used for various semiconductor packages in accompany with a suitable second circuit board and a suitable interposer that are cost-effectively fabricated by simplified processes, thereby reducing process complexity and fabrication costs for the test fixture.

In addition, the second circuit board of the test fixture is structured with thin layers, and provides structural flexibility and buffering effect without damaging semiconductor packages accommodated on the second circuit board, thereby eliminating drawbacks in the prior art of mounting semiconductor packages directly on a rigid multilayer circuit board that would easily damage package structures. Further by forming of elastic mechanisms on a covering member abutting against the semiconductor packages disposed on the second circuit board, the semiconductor packages are pressed by the elastic mechanism toward the second circuit board to be well electrically connected to the test fixture; elastic properties of the elastic mechanisms and buffering effect of the second circuit board would not damage structure of the semiconductor packages, thereby assuring yield of package products.

### BRIEF DESCRIPTION OF THE DRAWINGS

The present invention can be more fully understood by reading the following detailed description of the preferred embodiments, with reference made to the accompanying drawings, wherein:

FIG. 1A (PRIOR ART) is a perspective view of a conventional test fixture for accommodating semiconductor packages thereon;

FIG. 1B (PRIOR ART) is a cross-sectional view of the conventional test fixture of FIG. 1A mounted with semiconductor packages;

FIG. 2 is a schematic diagram showing perspective and cross-sectional view of components of a test fixture of the invention;

FIG. 3 is a cross-sectional view of the test fixture of the invention mounted with semiconductor packages; and

FIGS. 4A-4E are cross-sectional schematic diagrams showing process steps for a test method of using the test fixture of the invention.

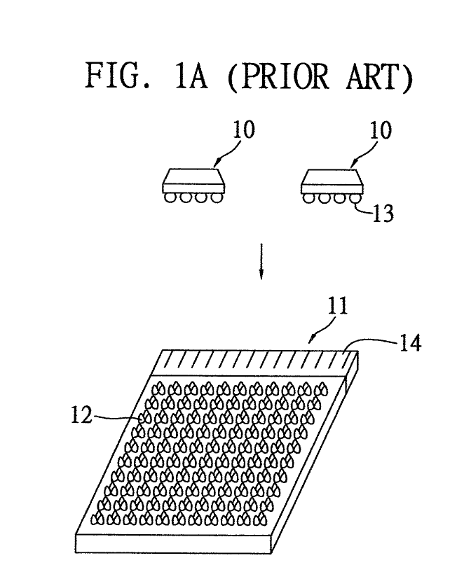

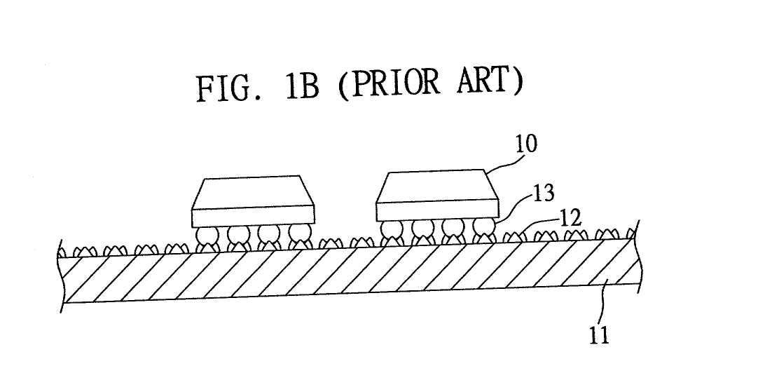

### DETAILED DESCRIPTION OF THE PREFERRED EMBODIMENT

Preferred embodiments for a test fixture proposed in the present invention are described in more detail as follows with reference to FIGS. 2 to 4. The drawings only illustrate components or parts of the test fixture in simplicity; it should be understood that, these components or parts are not drawn in real sizes or numbers, and the test fixture of the invention is structurally more complex in practical fabrication.

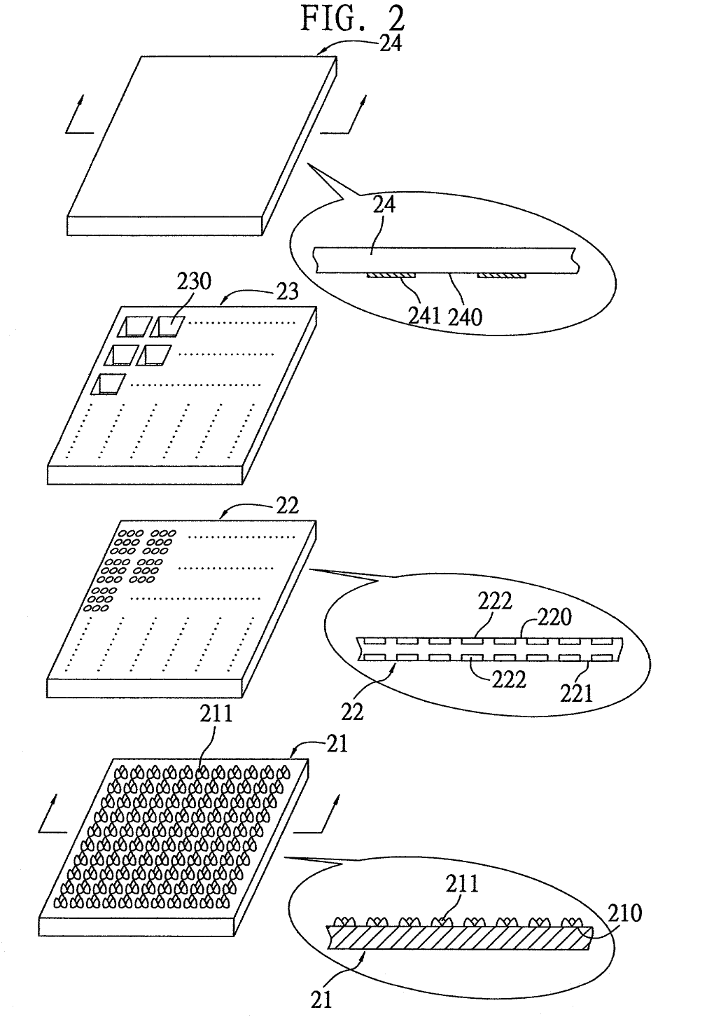

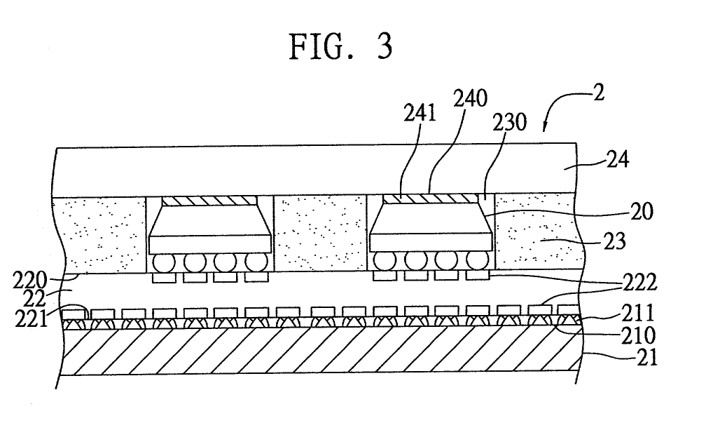

FIG. 2 illustrates components of a test fixture 2 of the invention; FIG. 3 illustrates the test fixture 2 of the invention mounted with semiconductor packages 20. As shown in the drawings, the test fixture 2 is used to electrically connect a plurality of semiconductor packages 20 e.g. BGA (ball grid array) semiconductor packages to a test device (not shown) where functional tests are performed for the semiconductor packages 20.

The test fixture 2 comprises: a first circuit board 21 formed on a surface 210 thereof with a plurality of contact mechanisms 211, and adapted to be electrically connected to the test device; a second circuit board 22 having an upper surface 220 and a lower surface 221 opposed to the upper surface 220, wherein the upper surface 220 is adapted for accommodating a plurality of semiconductor packages 20 thereon, and the lower surface 221 is mounted on the contact mechanisms 211 of the first circuit board 21 in a manner that, the second circuit board 22 is interposed between the semiconductor packages 20 and the first circuit board 21, allowing the semiconductor packages 20 to be electrically connected to the first circuit board 21 and the test device by the second circuit board 22; an interposer 23 mounted on the upper surface 220 of the second circuit board 22, and formed with a plurality of through holes 230 that penetrate through the interposer 23, so as to allow the semiconductor packages 20 mounted on the second circuit board 22 to be received in the through holes 230; and a covering member 24 mounted on the interposer 23, for covering the semiconductor packages 20 received in the through holes 230, wherein a plurality of elastic mechanisms 241 are formed on the covering member 24 corresponding in position to the through holes 230 of the interposer 23, and adapted to be interposed between the covering member 24 and the semiconductor packages 20.

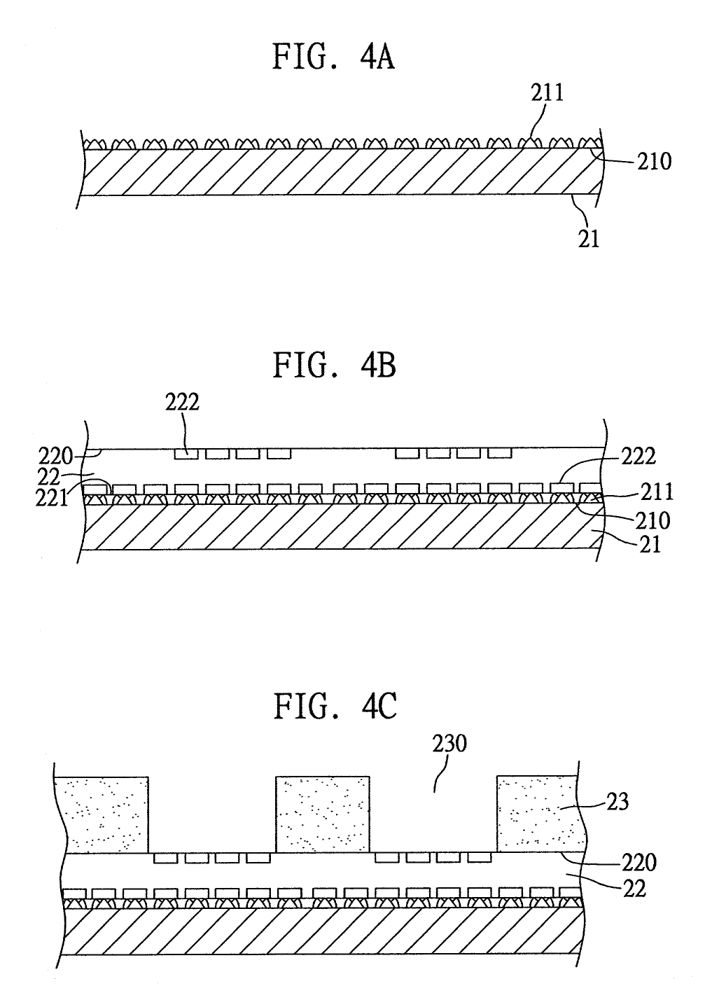

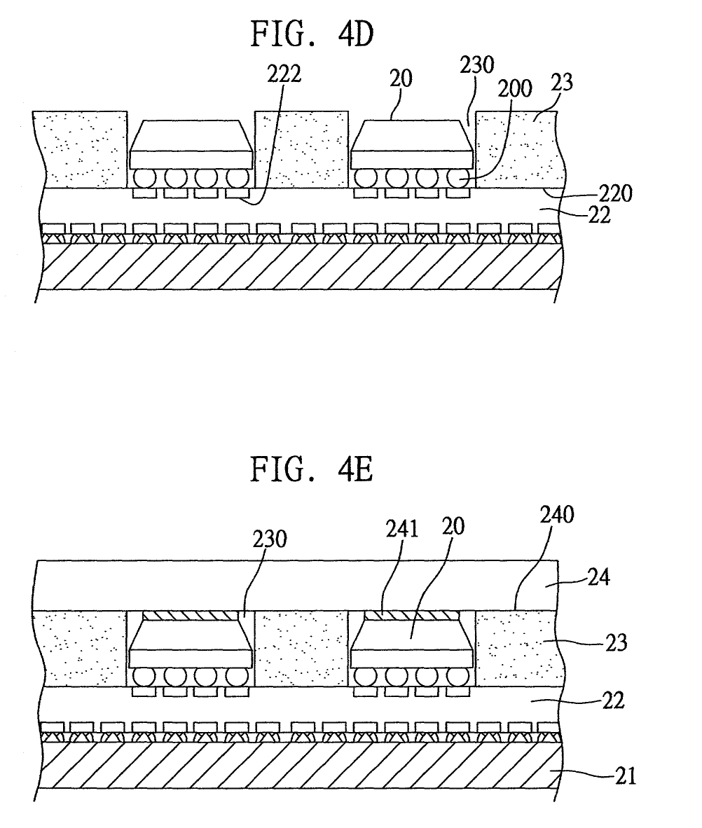

FIGS. 4A-4E illustrate process steps for a test method of using the test fixture 2 of the invention. The test method adopts the above test fixture 2 for electrically connecting a plurality of semiconductor packages to a test device where functional tests are performed, e.g. direct current test, bum-in test, room/cold test, hot sort test, etc; since these tests are conventional in the art, they are not to be further described herein. By performing the functional tests, good-quality semiconductor packages can be determined and selected as to eliminate inferior packages, thereby improving yield of fabricated products.

The test method of the invention is detailed as follows with reference to FIGS. 4A to 4E.

Referring to FIG. 4A, the first step is to prepare a first circuit board 21, which is formed with predetermined patterning of conductive traces (not shown), and usually structured with multiple layers (e.g. more than ten layers, or even several decades of layers). The first circuit board 21 is formed on a surface 210 thereof with a plurality of contact mechanisms 211 for electrical contact use. The contact mechanisms 211 can be, but not limited to, contact terminals made of an electrically conductive material; it should be understood that, other electrical contact means are also suitably applied herein as the contact mechanisms 211 of the invention.

Referring to FIG. 4B, the next step is to prepare a second circuit board 22 having an upper surface 220 and a lower surface 221 opposed to the upper surface 220. The upper and lower surfaces 220, 221 are each formed with a plurality of bond pads 222, allowing the lower surface 221 of the second circuit board 22 to be mounted on the surface 210 of the first circuit board 21 in a manner that, the bond pads 222 on the lower surface 221 come into contact with the contact mechanisms 211 of the first circuit board 21. Compared to the first circuit board 21, the second circuit board 22 is much simpler in structure (e.g. a double-layer structure), and can be fabricated by thin layers of polyimide or other materials. Therefore, the second circuit board 22 would provide structural flexibility and buffering effect, without damaging semiconductor packages (not shown) that are intended to be accommodated on the second circuit board 22, thereby eliminating drawbacks in the prior art of mounting semiconductor packages directly on a rigid multilayer circuit board that would easily damage package structures.

Referring to FIG. 4C, an interposer 23 is prepared and mounted on the upper surface 220 of the second circuit board 22. The interposer 23 is made of an insulating material and formed with a plurality of through holes 230 that penetrate through the interposer 23. The through holes 230 are respectively dimensioned to completely receive semiconductor packages (not shown) that are intended to be accommodated on the second circuit board 22.

Referring to FIG. 4D, a plurality of semiconductor packages 20 e.g. BGA semiconductor packages are disposed respectively in the through holes 230 of the interposer 23 in a manner that, the semiconductor packages 20 are accommodated on the upper surface 220 of the second circuit board 22, and input/output (I/O) connections 200 such as solder balls of the semiconductor packages 20 come into contact with the bond pads 222 formed on the upper surface 220 of the second circuit board 22. This therefore allows the semiconductor packages 20 to be electrically connected to the first circuit board 21 by the second circuit board 22.

Referring finally to FIG. 4E, a covering member 24 is prepared and mounted on the interposer 23 for covering the semiconductor packages 20 received in the through holes 230. A plurality of elastic mechanisms 241 are formed on a surface 240 of the covering member 24 corresponding in position to the through holes 230 of the interposer 23, and adapted to be interposed between the covering member 24 and the semiconductor packages 20; by provision of the elastic mechanisms 241, the semiconductor packages 20 can be firmly held in position within the through holes 230 of the interposer 23. The elastic mechanisms 241 are preferably dimensioned respectively in a manner as to completely cover the corresponding semiconductor packages 20, so as to allow the semiconductor packages 20 to be evenly in contact with the second circuit board 22.

The elastic mechanisms 241 can be made of elastomer, springs and so on; nevertheless, other elastic means may also be suitably adopted for the test fixture 2 of the invention.

With the semiconductor packages 20 being assembled to the test fixture 2 of the invention, the semiconductor packages 20 are readily subject to functional tests. By electrically connecting the first circuit board 21 of the test fixture 2 to a test device such as a test oven (not shown), the semiconductor packages 20 can be in turn electrically coupled to the test device through the first and second circuit boards 21, 22, such that the test device can perform various tests for testing functionality of the semiconductor packages 20. This therefore completes the test method of using the test fixture 2 of the invention.

In conclusion, the test fixture of the invention provides significant benefits. First, the test fixture is additionally provided with a second circuit board for mediating electrical connection between semiconductor packages and a first circuit board in a manner that, 1/0 connections (such as solder balls) of the semiconductor packages are in contact with an upper surface of the second circuit board (i.e. point-to-surface contact), and a lower surface of the second circuit board is in contact with contact mechanisms of the first circuit board (i.e. surface-to-point contact). Compared to the prior art of disposing I/O connections of semiconductor packages directly on contact mechanisms of a circuit board (i.e. point-to-point contact), which may easily lead to problems of incomplete electrical connection, the point-to-surface or surface-to-point contact of the invention can more firmly assure electrical connection between the semiconductor packages and second circuit board and between the second circuit board and first circuit board, such that the semiconductor packages would be completely electrically coupled through the first and second circuit boards to a test device where functional tests are performed.

Moreover, the test fixture of the invention can be applied to semiconductor packages of different sizes and with various densities in arrangement of I/O connections. With provision of the second circuit board being interposed between the semiconductor packages and the first circuit board, for accommodating semiconductor packages with various densities of I/O connections, the test fixture can be simply replaced with a second circuit board having bond pads arranged corresponding in density or position to I/O connections of the semiconductor packages. For accommodating semiconductor packages of different sizes, the test fixture can use an interposer formed with through holes corresponding in dimension to the semiconductor packages, whereby the semiconductor packages can be properly received in the through holes and firmly held in position on the second circuit board. In the invention, a single first circuit board is universally used for various semiconductor packages in accompany with a suitable second circuit board and a suitable interposer that are cost-effectively fabricated by simplified processes, thereby reducing process complexity and fabrication costs for the test fixture.

In addition, the second circuit board of the test fixture is structured with thin layers, and provides structural flexibility and buffering effect without damaging semiconductor packages accommodated on the second circuit board, thereby eliminating drawbacks in the prior art of mounting semiconductor packages directly on a rigid multilayer circuit board that would easily damage package structures. Further by forming of elastic mechanisms on a covering member abutting against the semiconductor packages disposed on the second circuit board, the semiconductor packages are pressed by the elastic mechanism toward the second circuit board to be well electrically connected to the test fixture; elastic properties of the elastic mechanisms and buffering effect of the second circuit board would not damage structure of the semiconductor packages, thereby assuring yield of package products.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A test fixture for semiconductor packages, for electrically connecting a plurality of semiconductor packages to a test device where tests are performed for the semiconductor packages; the test fixture comprising:
a first circuit board formed on a surface thereof with a plurality of contact mechanisms, and adapted to be electrically connected to the test device;
a second circuit board having an upper surface and a lower surface opposed to the upper surface, wherein the upper surface is adapted for accommodating a plurality of semiconductor packages thereon, and the lower surface is mounted on the contact mechanisms of the first circuit board in a manner that, the second circuit board is interposed between the semiconductor packages and the first circuit board, allowing the semiconductor packages to be electrically connected to the first circuit board and the test device by the second circuit board;
an interposer mounted on the upper surface of the second circuit board, and formed with a plurality of through holes that penetrate through the interposer, so as to allow the semiconductor packages accommodated on the second circuit board to be received in the through holes respectively; and
a covering member mounted on the interposer, for covering the semiconductor packages received in the through holes.

2. The test fixture of claim 1, wherein the semiconductor packages are each provided with a plurality of input/output (I/O) connections that come into contact with the upper surface of the second circuit board.

3. The test fixture of claim 2, wherein the second circuit board is formed with a plurality of bond pads on the upper and lower surfaces thereof respectively in a manner that, the bond pads on the upper surface are in contact with the I/O connections of the semiconductor packages, and the bond pads on the lower surface are in contact with the contact mechanisms of the first circuit board.

4. The test fixture of claim 3, wherein the input/output connections are solder balls.

5. The test fixture of claim 1, wherein the interposer is made of an insulating material.

6. The test fixture of claim 1, wherein the interposer is dimensioned in a manner as to allow the semiconductor packages to be completely received in the through holes.

7. The test fixture of claim 1, wherein a plurality of elastic mechanisms are formed on the covering member corresponding in position to the through holes of the interposer, and adapted to be interposed between the covering member and the semiconductor packages.

8. The test fixture of claim 7, wherein each of the elastic mechanisms is dimensioned in a manner as to completely cover the corresponding semiconductor package, so as to allow the semiconductor package to be evenly in contact with the second circuit board.

9. A test method of using a test fixture for semiconductor packages, for electrically connecting a plurality of semiconductor packages to a test device where tests are performed for the semiconductor packages; the test method comprising the steps of:
preparing a first circuit board, the first circuit board being formed on a surface thereof with a plurality of contact mechanisms;
preparing a second circuit board, the second circuit board having an upper surface and a lower surface opposed to the upper surface, and mounting the lower surface of the second circuit board on the contact mechanisms of the first circuit board;
mounting an interposer on the upper surface of the second circuit board, the interposer being formed with a plurality of through holes that penetrate through the interposer;
disposing a plurality of semiconductor packages respectively in the through holes of the interposer in a manner as to accommodate the semiconductor packages on the upper surface of the second circuit board, allowing the semiconductor packages to be electrically connected to the first circuit board by the second circuit board;
attaching a covering member to the interposer, for covering the semiconductor packages received in the through holes; and
electrically connecting the first circuit board to the test device, so as to allow the semiconductor packages to be electrically connected to the test device where tests are performed.

10. The test method of claim 9, wherein the semiconductor packages are each provided with a plurality of input/output (I/O) connections that come into contact with the upper surface of the second circuit board.

11. The test method of claim 10, wherein the second circuit board is formed with a plurality of bond pads on the upper and lower surfaces thereof respectively in a manner that, the bond pads on the upper surface are in contact with the I/O connections of the semiconductor packages, and the bond pads on the lower surface are in contact with the contact mechanisms of the first circuit board.

12. The test method of claim 11, wherein the input/output connections are solder balls.

13. The test method of claim 9, wherein the interposer is made of an insulating material.

14. The test method of claim 9, wherein the interposer is dimensioned in a manner as to allow the semiconductor packages to be completely received in the through holes.

15. The test method of claim 9, wherein a plurality of elastic mechanisms are formed on the covering member corresponding in position to the through holes of the interposer, and adapted to be interposed between the covering member and the semiconductor packages.

16. The test method of claim 15, wherein each of the elastic mechanisms is dimensioned in a manner as to completely cover the corresponding semiconductor package, so as to allow the semiconductor package to be evenly in contact with the second circuit board.
